(19) United States
(12) Patent Application Publication
(10) Pub. No.: US 2008/0214973 A1
(43) Pub. Date: Sep. 4, 2008

(54) Therapeutic Treatment Device

(76) Inventor: Achim Von Othegraven, Putzing (AT)

Correspondence Address: COLLARD & ROE, P.C., 1077 NORTHERN BOULEVARD, ROSLYN, NY, 11576, US

(21) Appl. No.: 10/569,857

(22) PCT Filed: Aug. 27, 2004
(86) PCT No.: PCT/AT2004/000294

§ 371 Date: Oct. 3, 2006

(30) Foreign Application Priority Data
Aug. 29, 2003 (AT) A 1360/2003

(51) Int. Cl. A61H 1/00

(52) U.S. Cl. 601/46

(57) ABSTRACT

A therapeutic treatment device having a contact surface for the patient, at least one acoustic body (1) being attached below the contact surface, which generates sound waves having a frequency below 100 Hz, which lie within predefined, discrete frequency bands, and an operating unit (4) having multiple operating elements (9) for controlling the at least one acoustic body (1) being provided, in which each operating element (9) is assigned to a predefined, discrete frequency band below 100 Hz and allows its selection.

The present invention relates to a therapeutic treatment device according to the preamble of claim 1.

Therapeutic treatments with the aid of manual treatment techniques are well-known. In this case, the hands of the therapist exert tension and compression forces to loosen the ligaments and muscles of the patient, which displays a therapeutic effect, depending on the indication and treatment technique, such as mobilization of joints, better drainage of bodily fluids such as lymph, improved circulation of tissue and organs, and much more. Due to the use of the hands of the therapist, treatment techniques of this type have local character, i.e., therapeutic intervention through contact is always restricted to a narrowly delimited bodily region, although the effect of this therapeutic intervention may radiate to the entire body of the patient, as is the case with osteopathic treatment techniques, for example.

Treatment methods of this type do not view the individual organs in an isolated way, but rather assume that pains in one body part may have their cause somewhere entirely different. Internal organs and bones are connected to one another via ligaments, muscles, and nerves. If a body part is sick or injured, other organs may be disturbed in a type of chain reaction. Thus, for example, kidney pains are not always caused by a kidney inflammation or kidney stones. It may also be the hip muscle, which the kidneys slide onto and off of approximately 600 times a day during breathing. If this muscle is cramped, e.g., through poor posture, breathing and kidney function are also impaired. In osteopathic treatment techniques, muscle cramps are loosened, ligaments are stretched, and adhesions are loosened using targeted, soft pressure massages with the fingertips. Good results are achieved in this case, for example, for back, knee, and jaw pains, diarrhea and constipation, migraines and menstrual pains, for chronic sinus and bladder inflammations, for sudden deafness, tinnitus, or even asthma.

The relative position of the internal organs and bones connected to one another via ligaments, muscles, and nerves is obviously changeable, internal organs and bones may be displaced slightly in relation to one another. From a mechanical viewpoint, ligaments, filaments, tendons, and muscles form elastic couplings between internal organs and bones, the relative position of internal organs and bones in turn having an effect on the ligaments, filaments, tendons, and muscles which connect them. From a mechanical viewpoint, coupling circuits are thus implemented, which represent resonant systems. Due to the type and strength of the coupling or feedback, specific organs and bones have a stronger mutual connection to one or another organ, muscle, tissue, or bone than to another. It is therefore to be expected that specific organs, muscles, tissue, or bones form a shared, resonant system and may be identified as such, which may also be referred to as a resonant circuit according to the resonance theory of physics. Furthermore, other organs, muscles, tissue, or bones may form other resonant circuits. These different resonant circuits are to be findable and identifiable via their resonance frequencies. In the following, however, the term “functional circuit” is used for these resonant circuits, since practical experience of the applicant has shown that specific glands and hormones are also assigned to these resonant circuits, for example. Imagining a merely mechanical resonant system would therefore be too restricted. Instead, these resonant circuits are linked to specific physiological functions, so that the term functional circuit appears more fitting.

In fact, theoretical and practical investigations of the applicant suggest seven functional circuits:

The first functional circuit comprises the solid components of spinal column, bones, teeth, and nails as well as both legs, anus, rectum, large intestine, straight intestine, colon, and the prostate. The adrenal glands and the hormones adrenaline and noradrenaline may be assigned to this functional circuit. Furthermore, in regard to physiological linkage, the blood and general cell degradation appear to be especially linked to this functional circuit.

The second functional circuit comprises the pelvis, the reproductive organs, the kidneys, and the bladder. The gonads, the ovaries, the testicles, and also the prostate, as well as estrogen and testosterone, may be assigned to this functional circuit. Furthermore, in regard to the physiological linkage, lymph, digestive juices, and sperm appear to be especially linked to this functional circuit.

The third functional circuit comprises the lower back, the abdominal cavity, the digestive system, the stomach, the liver, the spleen, and the gallbladder. The pancreas and insulin may be assigned to this functional circuit. Furthermore, in regard to the physiological linkage, the vegetative nervous system appears to be especially linked to this functional circuit.

The fourth functional circuit comprises the upper back, the heart, the rib cage, and the thoracic cavity, the lower lung area, as well as the skin and the hands. The thymus gland and the thymus hormone may be assigned to this functional circuit. Furthermore, in regard to the physiological linkage, the circulatory system appears to be especially linked to this functional circuit.

The fifth functional circuit comprises the lungs, the bronchi, the esophagus, the speech apparatus, the throat, the neck, the jaw, and the maxillary bone. The thyroid gland and the parathyroid gland as well as the hormone thyroxine may be assigned to this functional circuit.

The sixth functional circuit comprises the cerebellum, the ears, the nose, the sinuses, the eyes, the forehead, and the face. The pituitary gland and the hormones vasopressin and pituitrine may be assigned to this functional circuit. Furthermore, in regard to the physiological linkage, the nervous system appears to be especially linked to this functional circuit.

The seventh functional circuit comprises the cerebrum and the roof of the skull. The epiphysis and the hormones serotonin and melatonin may be assigned to this functional circuit.

However, mere manual manipulation, which usually only has a local effect, is insufficient for a therapeutic interaction with these functional circuits. It has now been shown that resonance frequencies may actually be assigned to these functional circuits, via which a stimulation of the entire functional circuit may be achieved. Since these functional circuits are mechanical systems having magnitudes from centimeters to meters from a physical viewpoint, it is to be expected that resonance frequencies lie in the magnitude from 20 Hz to 100 Hz and each individual resonance frequency moves in narrow, discrete frequency bands, as is the case for resonant circuits. Precisely this state of affairs was observed in therapeutic practice. Thus, a frequency band of 31 Hz to 33 Hz may be assigned to the first functional circuit, a frequency band of 35.5 Hz to 37.5 Hz may be assigned to the second functional circuit, a frequency band of 40 Hz to 42.5 Hz may be assigned to the third functional circuit, a frequency band of 44.5 Hz to 46.5 Hz may be assigned to the fourth functional circuit, a frequency band of 49 Hz to 51 Hz may be assigned to the fifth functional circuit, a frequency band of 54 Hz to 56 Hz may be assigned to the sixth functional circuit, and a frequency band of 58.5 Hz to 60.5 Hz may be assigned to the seventh functional circuit.

The object of the present invention is therefore a therapeutic treatment device which exploits the state of affairs of different functional circuits and allows stimulation of individual functional circuits via their resonance frequencies. This object is achieved by the implementation of the measures according to claim 1.

For this purpose, claim 1 provides a therapeutic treatment device having a contact surface for the patients, at least one acoustic body being attached below the contact surface, which generates sound waves having a frequency below 100 Hz which lie within predefined, discrete frequency bands, as well as an operating unit having multiple operating elements for controlling the at least one acoustic body, an operating element being assigned to each of these discrete frequency bands below 100 Hz and allowing its selection. The resonance frequencies of the functional circuits are in the individual frequency bands. If seven functional circuits are assumed, therefore, seven frequency bands are provided, within each of which the resonance frequency of one functional circuit lies. Although physical systems have very sharply defined resonance frequencies, this is not the case in the biological functional circuits according to the object, so that frequency bands are discussed here. In principle, it is assumed that because of this fuzziness of the resonance frequency, different frequencies within a frequency band are equally suitable for exciting the particular functional circuit. Frequencies outside this frequency band may no longer excite the corresponding functional circuit, since they are too strongly out of resonance with the relevant functional circuit to be able to be of therapeutic interest. Depending on the therapeutic indication, one or even more frequencies are thus generated for a specific period of time, preferably in sequence, and different functional circuits are thus treated. Of course, it is also conceivable that a specialized device for treating a specific functional circuit provides the reproduction of only one frequency. This case shall also be encompassed by claim 1. Easy operability of the at least one acoustic body is achieved through the operating unit, since the operator only has to actuate an operating element, such as a pushbutton, a switch, or a selection field of a corresponding software program which may be selected by mouse, to select a specific frequency band.

Claim 2 provides an advantageous embodiment of the treatment device, according to which precisely two acoustic bodies are provided. Expediently, according to Claim 3, one of these is positioned below the contact surface in such way that when a patient is lying on the contact surface, it comes to rest below the pelvic area of the patient and the second comes to rest below the chest area. Therefore, the entire body of the patient may be exposed to sonic waves optimally.

Claims 4 to 10 specify frequency bands for the choice of seven functional circuits.

According to Claim, 4, the operating unit is equipped with an operating element for amplitude modulation of the sound waves of the at least one acoustic body. Different sensitivities of patients may thus be taken into consideration, or the therapeutic intervention may also be implemented at different strengths.

Claims 12 through 15 provide that a sine wave generator and a pulse shaper are provided, the pulse shaper converting the sinusoidal oscillations generated by the sine wave generator into a sawtooth vibration, square wave vibration, triangular vibration, or a pulsed vibration. These different pulse shapes have different therapeutic properties depending on their overtone content, resonance properties with the particular functional circuit, or pulse-characteristic energy input and thus allow possibilities for optimization in therapeutic practice.

Furthermore, it is conceivable that the at least one acoustic body of the treatment device according to the present invention is activated via a commercially available CD player, for example, the CD used containing sound frequencies within the frequency bands specified above as the audio information. Therefore, Claim 16 claims treatment devices having storage media for audio signals, such as CDs, the audio signals essentially having frequencies which lie within predefined, discrete frequency bands below 100 Hz.

The present invention will now be explained in greater detail on the basis of the attached figures.

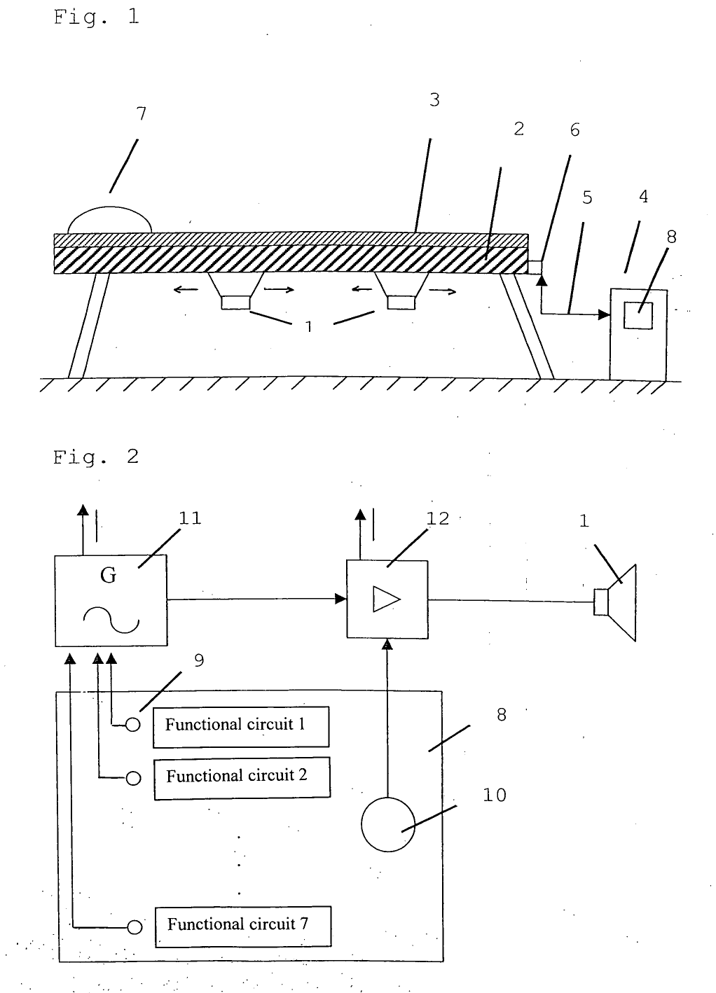

FIG. 1 shows a schematic illustration of an embodiment of a treatment device according to the present invention,

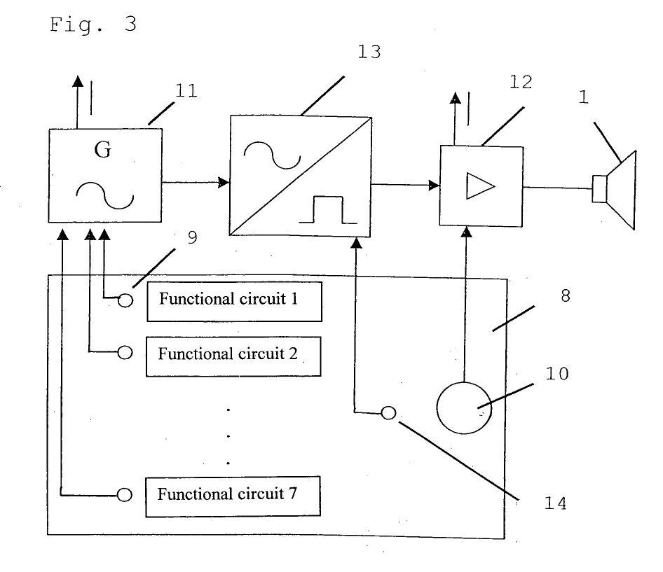

FIG. 2 shows a block diagram of an embodiment of the operating unit and attached acoustic body, and

FIG. 3 shows a block diagram of a further embodiment of the operating unit using a pulse shaper and attached acoustic body.

At least one contact surface is provided for implementing the treatment device according to the present invention, which is formed by a solid, stable support plate 2 and an elastic reclining layer 3, made of a foam material, for example, according to the embodiment of FIG. 1. At least one acoustic body 1 is attached below the support plate 2, which is preferably manufactured from wood. An embodiment is shown in FIG. 2 in which two acoustic bodies 1 are used, the acoustic bodies being positioned below the support plate 2 in such way that when a patient reclines on the reclining layer 3, one acoustic body 1 comes to rest below the pelvic area of the patient and the second acoustic body 1 comes to rest below the chest area of the patient. The head of the reclining patient is supported in this case by a cushion or a neck support 7, for temple. The acoustic bodies 1 may also be attached to rails below the support plate 2, for example, in order to allow displacement of the acoustic bodies 1 and therefore adaptation to the particular patients (indicated in FIG. 1 by the horizontal arrows).

Of course, FIG. 1 only shows the simplest embodiment variation of a contact surface, different shapes are conceivable, however, a curved embodiment of the contact surface is advantageous in practice, for example, the shape of the contact surface being adapted to the curvature of the spinal column and ensuring support of the head. The reclining layer 3 may also be implemented as somewhat elevated in the area which comes to rest below the spinal column of a patient reclining thereon, so that the muscles surrounding the spinal column are loaded by pressure less and may thus relax better.

The acoustic bodies 1 are loudspeakers which are especially suitable for reproducing frequencies below 100 Hz. Loudspeakers of this type are also known as “subwoofers”. According to the present invention, however, the acoustic bodies 1 are mounted without a diaphragm on the support plate 2, through which the vibrations are transmitted directly to the support plate 2. These vibrations are transmitted directly to the body of the patient and are perceptible as low-frequency vibrations. Through the direct transmission of these vibrations to the body instead of an acoustic perception, these vibrations are also not subject to cognitive filtering. If two acoustic bodies 1 are provided, the interference of the generated vibrations in the body of the patient causes a reinforcing effect.

The acoustic bodies are connected using a connection socket 6 and via cables 5 to the operating unit 4. The operating unit 4 may be an appropriate operating console having an operating panel 8, in which operating elements such as switches, push buttons, or keys 9, 14 as well as rotary knobs 10 are provided. Of course, the acoustic bodies 1 may also be activated via a computer, the settings performed by the operating elements 9, 14, 10 being able to be performed by mouse click. The operating unit 4 would be a computer in this case. Alternatively to this, it would also be easily conceivable to perform the activation of the acoustic bodies 1 simply via a commercially available CD player, a CD being used which essentially contains frequencies lying within predefined, discrete frequency bands below 100 Hz as audio signals. “Essentially” in this context means that other audio signals may also be played back simultaneously, for example, which have a more relaxing than therapeutic effect, such as ocean noises or the like.

In the following an embodiment according to FIGS. 2 and 3 is assumed. For this purpose, an operating unit 4 is provided with an operating panel 8. If seven functional circuits are assumed, for example, the operating field 8 allows the selection of the frequencies corresponding to these functional circuits, for example, by actuating the corresponding operating element 9, e.g., a key 9. Thus, for example, when a first key 9 is actuated, an oscillator 11 is set so that it generates a sinusoidal voltage having a frequency in the range from 31 Hz to 33 Hz. This voltage is amplified by an amplifier 12 and supplied to the acoustic body 1, which stimulates the first functional circuit of the patient. The amplifier 12 may be set for this purpose via an operating element 10, such as a rotary knob 10, on the operating panel 8 and allows an output signal having a power of 20-100 W in practical implementation. The operating element 10 thus allows the amplitude modulation of the sound waves generated by the acoustic body 1. Different sensitivities of patients may thus be taken into consideration, or the therapeutic intervention may also be implemented at different strengths.

Different frequencies may be generated alternately in sequence by actuating different keys 9, through which different functional circuits of the patients are addressed in each case. Furthermore, a key 9 may also be provided, which generates all frequencies of the seven functional circuits in sequence, which is perceived by the patient as a “wave” beginning at low-frequency vibrations, which become increasingly higher frequency and finally end at low frequencies again.

As already noted, physical systems to have very sharply defined resonance frequencies, but this is not the case for the biological functional circuits according to the object, so that frequency bands are discussed here. In principle, it is assumed that because of this fuzziness of the resonance frequency, different frequencies within a frequency band are equally suitable for exciting the particular functional circuit. In the practical implementation, a specific frequency within the corresponding frequency band is assigned to each key 9 in the construction of the treatment device through suitable layout of the electronic components, so that upon actuating this key 9 in the course of therapeutic practice, this previously fixed frequency is always generated. Therefore, varying the frequency assigned to a specific key within the corresponding frequency band is typically not provided in the course of application. Rather, the variability of a frequency within the corresponding frequency band is significant in the production of the treatment device. However, it is conceivable in principle to allow the therapist to also implement the frequency assigned to a specific key 9 as variable within the corresponding frequency band through a corresponding regulator, in order to optimize a therapeutic effect, for example.

Through the embodiment according to FIG. 2, because of the use of a sine wave generator 11, sound waves are generated which are based on sinusoidal oscillations. Tones of this type do sound very pure and aesthetic, but do not have any overtones. It has been shown in therapeutic practice that in many cases vibrations especially rich in overtones are advantageous. Therefore, the embodiment according to FIG. 3 additionally provides a pulse shaper 13, which converts the sinusoidal oscillations of the oscillator 11 into a sawtooth vibration, which is further amplified by the amplifier 12 and supplied to the acoustic body 1. Sawtooth vibrations are very rich in overtones and contain the complete overtones series of even and odd overtones. An additional therapeutic effect is ascribed to these overtones. Alternatively to this, however, pulse shapers 13 which generate square wave vibrations from sinusoidal oscillations may also be provided. Square wave vibrations are also very rich in overtones, although the even-numbered overtones are missing. In addition, the pulsed exposure to sonic waves thus caused may have therapeutic advantages. In order to optimize the advantages of pulsed exposure to sonic waves, pulse shapers 13 which generate pulses having variable pulse widths, which also strongly changes the overtone content, may be provided. Thus, for example, through exposure to sonic waves using short pulses, the energy input may be bundled to short time intervals, which may also have therapeutic advantages. Furthermore, it is conceivable to provide a pulse shaper 13 which shapes triangular pulses. Triangular pulses are acoustically perceived as “soft” and not as aggressive as square wave pulses having a shorter pulse duration, for example. Therefore, multiple different pulse shapes are possible, which allow different possibilities for optimization in therapeutic practice depending on overtone content, resonance properties with the particular functional circuit, or pulse-characteristic energy input. Of course, an embodiment of the treatment device according to the present invention may also provide multiple pulse shapers 13, which may be selected with the aid of the operating element 14.

Depending on the medical indication, an individual program of exposure to sonic waves may thus be determined by the therapist, in that he addresses different functional circuits by selecting different frequencies. Without wanting to be fixed to a specific theory, it is assumed that through the deep relaxation achieved and through the energy introduced by the sound waves, which is converted into heat or ensures restructuring of tissue, ligaments, elements, or muscles, a therapeutic effect is achieved. Good results have been shown up to the date of application for back, knee, hip, and job pains, diarrhea and constipation, migraines and menstrual pains, and in chronic sinus and bladder inflammations.

1-16. (canceled)

17. A therapeutic treatment device having a contact surface for the patient, at least one acoustic body (1) being attached below the contact surface, which generates sound waves having a frequency below 190 Hz, which lie within predefined, discrete frequency bands, and an operating unit (4) having multiple operating elements (9) for activating the at least one acoustic body (1) being provided, wherein a first frequency band extends from 31 Hz to 33 Hz, a second frequency band extends from 35.5 Hz to 37.5 Hz, a third frequency band extends from 40 Hz to 42.5 Hz, a fourth frequency band extends from 44.5 Hz to 46.5 Hz, a fifth frequency band extends from 49 Hz to 51 Hz, a sixth frequency band extends from 54 Hz to 56 Hz, and a seventh frequency band extends from 58.5 Hz to 60.5 Hz, an operating element (9) being assigned to each of these discrete frequency bands and allowing its selection.

18. The therapeutic treatment device according to claim 17, wherein precisely two acoustic bodies (1) are provided.

19. The therapeutic treatment device according to claim 18, wherein the acoustic bodies (1) are positioned below the contact surface in such a way that when a patient reclines on the contact surface, one acoustic body (1) comes to rest below the pelvic area of the patient and the second acoustic body (1) comes to rest below the chest area of the patient.

20. The therapeutic treatment device according to claims 17, wherein the operating unit (4) is equipped with an operating element (10) for amplitude modulation of the sound waves of the at least one acoustic body (1).

21. The therapeutic treatment device according to claim 17, wherein a sine wave generator (11) and a pulse shaper (13) are provided, the pulse shaper (13) converting the sinusoidal oscillations generated by the sine wave generator (11) into a sawtooth vibration.

22. The therapeutic treatment device according to claim 17, wherein a sine wave generator (11) and a pulse shaper (13) are provided, the pulse shaper (13) converting the sinusoidal oscillations generated by the sine wave generator (11) into a square wave vibration.

23. The therapeutic treatment device according to claim 17, wherein a sine wave generator (11) and a pulse shaper (13) are provided, the pulse shaper (13) converting the sinusoidal oscillations generated by the sine wave generator (11) into a triangular vibration.

24. The therapeutic treatment device according to claim 17, wherein a sine wave generator (11) and a pulse shaper (13) are provided, the pulse shaper (13) converting the sinusoidal oscillations generated by the sine wave generator (11) into pulsed vibrations.

25. The therapeutic treatment device according to claim 17 having a storage medium for audio signals, wherein the audio signals essentially have frequencies which lie within predefined, discrete frequency bands below 100 Hz.
